(19) United States
(12) Patent Application Publication
(10) Pub. No.: US 2003/0234767 A1
(43) Pub. Date: Dec. 25, 2003

(54) Illuminating computer keyboard pointer

(76) Inventor: Masao Kanaya, Ishinomaki (JP)

Correspondence Address: SHINJYU GLOBAL IP COUNSELORS, LLP, 1233 20TH STREET, NW, SUITE 700, WASHINGTON, DC, 20036-2680, US

(21) Appl. No.: 10/178,516

(22) Filed: Jun. 25, 2002

(51) Int. Cl. G09G 5/00

(52) U.S. Cl. 345/168

(57) ABSTRACT

A computer keyboard with a pointer 1 that can be illuminated is provided. The pointer 1 has a translucent cover 2 and a light source 3. The light source 3 is connected to a power source 4. The pointer 1 functions like a mouse to direct the movement of an onscreen pointer, arrow, or the like.

### BACKGROUND OF THE INVENTION

1. Field of the Invention

This invention generally relates to a joystick or pointer for a computer keyboard. More specifically, the present invention relates to a computer keyboard joystick that cam be illuminated.

2. Background Information

Portable or laptop computers are prized for their small size and ability to be used in places in which desktop computers cannot. Portable computers are often used by people in transit, for example in a train or airplane. Often the places in which portable computers are used have insufficient lighting. The user is left to search for the joystick and/or keys on the keyboard. This searching results in wasted time and input errors.

In view of the above, there exists a need for a computer keyboard that overcomes the above-mentioned problems in the prior art. This invention addresses this need in the prior art as well as other needs, which will become apparent to those skilled in the art from this disclosure.

### SUMMARY OF THE INVENTION

An object of the present invention is to provide a computer keyboard with a pointer that can be seen and used in dark places.

A computer keyboard in accordance with a first aspect of the present invention has a joystick or pointer that is integrally assembled with the keyboard and can be illuminated.

A computer keyboard in accordance with a second aspect of the present invention is the keyboard of the first aspect wherein the joystick or pointer is illuminated with a light emitting diode (LED) disposed inside a translucent cover.

A computer keyboard in accordance with a third aspect of the present invention is the keyboard of the first or second aspect wherein the joystick or pointer is illuminated using a lithium battery as a power source.

A computer keyboard in accordance with a fourth aspect of the present invention is the keyboard of any of the previous aspects wherein the light or translucent cover is a specific color.

A computer keyboard in accordance with a fifth aspect of the present invention is the keyboard of any of the previous aspects wherein the translucent cover has a distal free end that is configured to display a design or logo. The design can be flush with the surface of the pointer, embossed, or engraved. Further, the design can be located on the top surface and/or side surface.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a perspective view of a laptop computer having a pointer in accordance with a preferred embodiment of the present invention;

FIG. 2 is a schematic perspective view of the pointer;

FIG. 3 is an elevational view of the pointer illustrating a cover design located on a side surface of the pointer;

FIG. 4 is plan view of the pointer illustrating a cover design located on a top surface of the pointer; and

FIG. 5. is a plan view of the pointer with a plurality of light sources.

### DETAILED DESCRIPTION OF THE PREFERRED EMBODIMENTS

Selected embodiments of the present invention will now be explained with reference to the drawings. It will be apparent to those skilled in the art from this disclosure that the following description of the embodiments of the present invention is provided for illustration only, and not for the purpose of limiting the invention as defined by the appended claims and their equivalents.

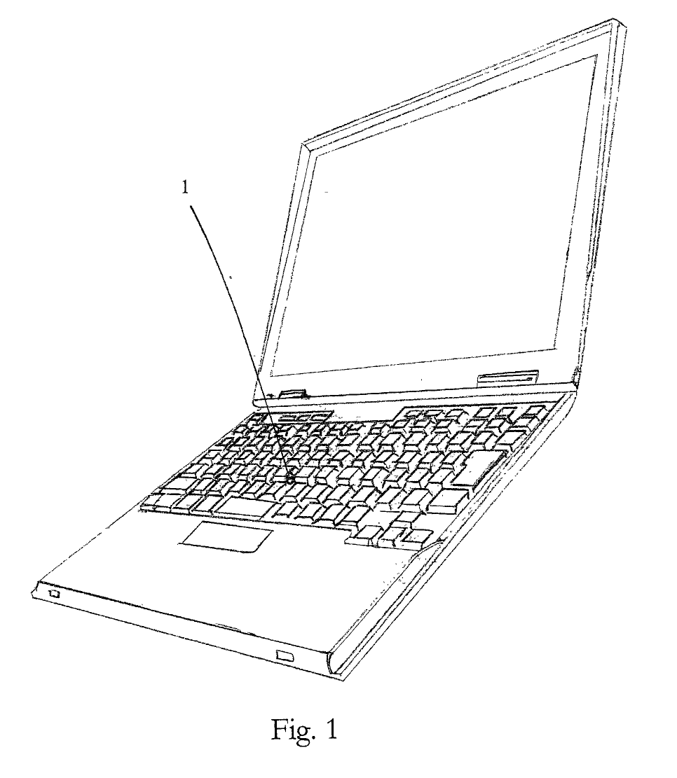

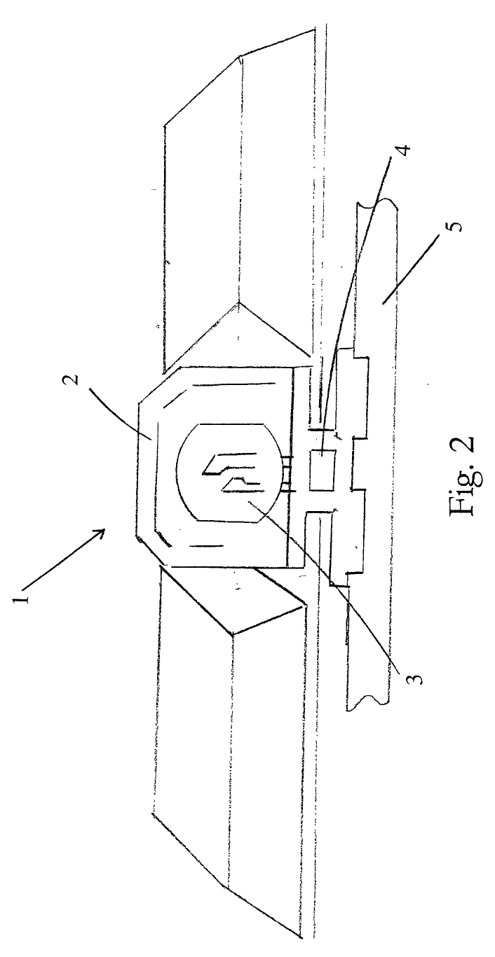

Referring initially to FIG. 1, a laptop computer having an illuminated pointer 1 is illustrated in accordance with a first embodiment of the present invention. As seen in FIG. 2, the pointer 1 preferably has a clear translucent cover 2. However, the translucent cover 2 can be colored as desired.

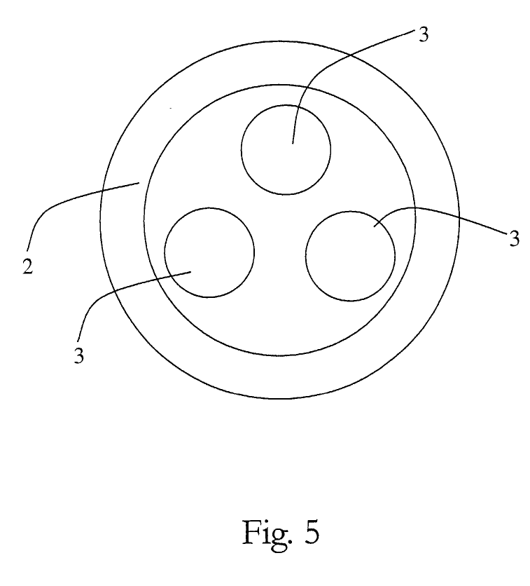

At least one LED 3 is disposed inside the cover 2. Alternatively, as seen in FIG. 5, a plurality of LEDs 3 can be disposed within the cover 2. The LEDs 3 can emit different color light separately or in combination as desired to signal the user that power is low, the computer is “sleeping,” etc. Referring again to FIG. 2, the LED 3 is connected to power source 4 that provides power when the computer is activated. In the case of a laptop computer, the power source 4 can also be arranged to provide power when the screen is raised or moved away from the keyboard. The power source 4 is preferably a lithium battery. However, the power source 4 can also be a conventional electrical outlet, automobile cigarette lighter, or the like.

The cover 2 is connected to a sensor 5 that functions like a mouse to direct movement of an onscreen pointer, arrow, or the like. A user moves the cover 2 left, right, forward, back, etc to effect movement of the onscreen pointer, arrow, or the like.

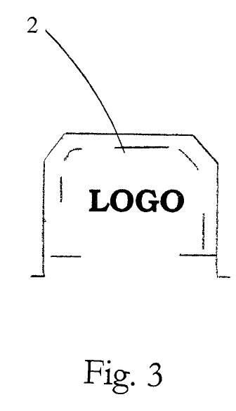

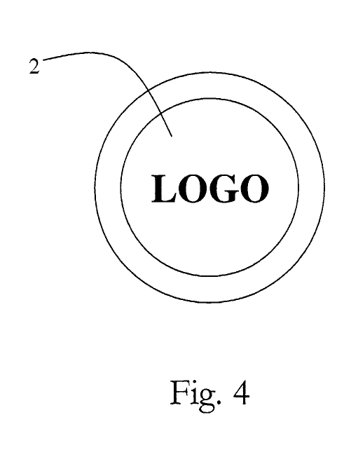

Referring to FIGS. 3 and 4, the cover can display a design or logo on the top (area of contact) and/or side (area that extends from the keyboard). The design can be an image, words, slogan, etc. The design or logo can be flush with the surface of the cover 2. However, the logo is preferably embossed or engraved in the cover such that the surface of the cover 2 is uneven. This uneven structure would more easily facilitate manipulation of the pointer through increased friction.

As used herein, the following directional terms “forward, rearward, above, downward, vertical, horizontal, below and transverse” as well as any other similar directional terms refer to those directions of a device equipped with the present invention. Accordingly, these terms, as utilized to describe the present invention should be interpreted relative to a device equipped with the present invention.

The terms of degree such as “substantially,” “about,” and “approximately” as used herein mean a reasonable amount of deviation of the modified term such that the end result is not significantly changed. These terms should be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. A computer keyboard comprising:
a pointer being integrally assembled with the keyboard, said pointer being illuminable.

2. The computer keyboard according to claim 1, wherein
said pointer comprises a translucent cover and a light emitting diode disposed inside said translucent cover.

3. The computer keyboard according to claim 2, wherein
said light emitting diode is illuminated using a lithium battery.

4. The computer keyboard according to claim 3, wherein
said translucent cover is tinted with a predetermined color.

5. The computer keyboard according to claim 4, wherein
said translucent cover further comprises a free distal end configured to display a first design.

6. The computer keyboard according to claim 5, wherein
said first design is embossed on or engraved in said free distal end.

7. The computer keyboard according to claim 6, wherein
said translucent cover further comprises a side surface extending from said computer keyboard configured to display a second design.

8. The computer keyboard according to claim 7, wherein
said second design is embossed on or engraved in said side surface.

9. The computer keyboard according to claim 5, wherein
said translucent cover further comprises a side surface extending from said computer keyboard configured to display a first design.

10. The computer keyboard according to claim 9, wherein
said first design is embossed on or engraved in said side surface.

11. The computer keyboard according to claim 10, wherein
said translucent cover further comprises a free distal end configured to display a second design.

12. The computer keyboard according to claim 11, wherein
said second design is embossed on or engraved in said free distal end.

13. The computer keyboard according to claim 1, wherein
said light emitting diode is illuminated using a lithium battery

14. The computer keyboard according to claim 13, wherein
said translucent cover is tinted with a predetermined color.

15. The computer keyboard according to claim 1, wherein
said pointer comprises a translucent cover and a plurality of light emitting diodes disposed inside said translucent cover.

16. The computer keyboard according to claim 15, wherein
said plurality of light emitting diodes emit different colors of light to signal a state of operation of a computer.

17. The computer keyboard according to claim 16, wherein
said plurality of light emitting diodes are configured to emit a color when remaining power recedes past a predetermined level.

18. The computer keyboard according to claim 17, wherein
said plurality of light emitting diodes is illuminated using at least one lithium battery.

19. The computer keyboard according to claim 18, wherein
said translucent cover is configured to display at least one design.

20. The computer keyboard according to claim 19, wherein
said at least one design is embossed on or engraved in said translucent cover.
